(19) United States
(12) Patent Application Publication
(10) Pub. No.: US 2023/0143520 A1
(43) Pub. Date: May 11, 2023

(54) HINGE STRUCTURE FOR IN-FOLDING TYPE DISPLAY DEVICE

(71) Applicant: AUFLEX CO., LTD., Hwaseong-si (KR)

(72) Inventors: Hyun Min PARK, Suwon-si (KR); Seoung Jun LEE, Uiwang-si (KR)

(21) Appl. No.: 17/910,913

(22) PCT Filed: Mar. 15, 2021
(86) PCT No.: PCT/KR2021/003192

§ 371 Date: Sep. 12, 2022

(30) Foreign Application Priority Data
Mar. 15, 2020 (KR) 10-2020-0031685
Mar. 16, 2020 (KR) 10-2020-0032305

(51) Int. Cl. H04M 1/02

(52) U.S. Cl. CPC H04M 1/0216; H04M 1/0268

(57) ABSTRACT

A hinge structure for an in-folding type display device is provided which allows a smartphone to be automatically folded or unfolded with an elastic force of a spring and in which the spring is disposed inside of foldable connecting plates instead of being disposed at positions of a fixing cam and a moving cam, whereby a large space for disposing the spring can be secured to use a spring with a large diameter.

### TECHNICAL FIELD

The invention relates to a hinge structure for a display device and, more particularly, to a hinge structure for an in-folding type display device which allows a smartphone to be automatically folded or unfolded with an elastic force of a spring and in which the spring is disposed inside of foldable connecting plates instead of being disposed at positions of a fixing cam and a moving cam, whereby a large space for disposing the spring can be secured to use a spring with a large diameter.

### BACKGROUND ART

Mobile communication terminals are configured to perform various functions. Examples of the functions include a data and speech communication function, a function of capturing a still image or a moving image using a camera, a speech storing function, a function of reproducing a music file using a speaker system, and a function of displaying a still image or a moving image (a video).

Some mobile communication terminals have additional functions for playing games, and some mobile communication terminals are embodied as multimedia devices. Recent mobile communication terminals can also receive broadcast or multicast signals and reproduce a video or a television program.

Researches for supporting and improving other functions of mobile communication terminals in addition to the above-mentioned functions have been carried out. These researches include modification and improvement of structural constituents of the mobile communication terminals and addition and improvement of software or hardware.

In general, a display module of a mobile communication terminal displays information which is processed by the mobile communication terminal. For example, when the mobile communication terminal is in a call mode, the display module displays a user interface (UI) or a graphic user interface (GUI) associated with a call.

When the mobile communication terminal is in a video call mode or an image capturing mode, the display module displays a captured or/and received image, a UI, or a GUI. The display module includes a liquid crystal display (LCD), a thin-film transistor liquid crystal display, an organic light emitting diode (OLED), a flexible display, or a 3D display.

A flexible display (or a flexible LCD) has been regularly researched with its merit of deformability. It takes much time to use a rolled display like a paper roll as shown in science-fiction movies.

Therefore, transitional forms of flexible displays will be many used until the flexible displays are regularly used with sufficient development thereof, and these transitional forms will be similar to current structures of communication terminals. Accordingly, there is necessity for description of usage and protection of flexible displays when such flexible displays are used in mobile communication terminals.

An example of such a hinge structure for a mobile communication terminal having a flexible display panel installed therein is disclosed in Korean Patent Application Laid-open No. 10-2015-0096827 (Title of the Invention: HINGE STRUCTURE AND FOLDABLE DISPLAY DEVICE INCLUDING THE SAME).

### SUMMARY OF INVENTION

### Technical Problem

An objective of the invention is to provide a hinge structure for an in-folding type display device which allows a smartphone to be automatically folded or unfolded with an elastic force of a spring and in which the spring is disposed inside of foldable connecting plates disposed on both sides of a rotating cam and a moving cam instead of being disposed at positions of the rotating cam and the moving cam, whereby a large space for disposing the spring can be secured to use a spring with a large diameter.

### Solution to Problem

In order to achieve the above-mentioned objectives, there is provided a hinge structure for an in-folding type display device, the hinge structure including: a pair of connecting plates that rotates in opposite directions; an elasticity unit that provides an elastic force to rotation of the connecting plates; a plate connecting portion that connects the pair of connecting plates; and an elastic connecting portion that connects the connecting plates and the elasticity unit by causing the elasticity unit to generate an elastic force when the pair of connecting plates rotate.

A rotating cam that rotates and a moving cam that moves straightly when the rotating cam rotates may be provided in the plate connecting portion.

A rotation link that supports rotation of the connecting plates may be provided in the plate connecting portion.

The rotation link may rotate along a rail, and the rail may rotate.

A long protrusion longer than the other protrusion may be formed in the rotating cam and the moving cam.

A diameter of the elasticity unit may be greater than a diameter of the rotating cam.

### Advantageous Effects of Invention

With the hinge structure for an in-folding type display device according to the invention, it is possible to install a spring with a large diameter and thus to fold and unfold a foldable smartphone with a sufficient elastic force.

In a folding hinge according to the related art using a rotating cam and a moving cam, a spring for applying an elastic force is disposed behind the moving cam that moves straightly with rotation of the rotating cam.

The diameter of the spring disposed behind the moving cam in the related art is limited by a diameter, a height, a width, or the like of the rotating cam or the moving cam. Accordingly, it is difficult to use a spring with a large diameter and thus the spring which is an elastic member does not provide a large elastic force.

When a foldable smartphone is performing a folding or unfolding operation, a battery and the like are mounted in two foldable panels and thus a weight thereof is considerably large. Accordingly, it is necessary to use a spring with a large elastic force in order to smoothly fold or unfold of the panels of the smartphone.

According to the invention, since a spring is not disposed behind a moving cam but can be disposed in each of a pair of connecting plates, it is possible to secure a larger space for disposing the spring and thus to use a spring with a larger diameter. Accordingly, it is possible to more smoothly perform a folding or unfolding operation of a smartphone using a spring with a larger elastic force.

### BRIEF DESCRIPTION OF DRAWINGS

FIG. 1 is a perspective view illustrating a state in which a flexible display panel is installed in a display device in which a hinge structure for an in-folding type display device according to the invention is provided.

FIG. 2 is a perspective view illustrating a state in which a lower cover is assembled with a hinge in the display device in which the hinge structure for an in-folding type display device according to the invention is provided.

FIG. 3 is a perspective view illustrating a state in which the hinge structure is coupled to one upper panel in the display device in which the hinge structure for an in-folding type display device according to the invention is provided.

FIG. 4 illustrates a perspective view of the hinge structure in which the upper panels are being folded in the display device in which the hinge structure for an in-folding type display device according to the invention is provided.

FIG. 5 illustrates a perspective view of the hinge structure in which the upper panels have been fully folded in the display device in which the hinge structure for an in-folding type display device according to the invention is provided.

FIG. 6 illustrates a perspective view of the hinge structure for an in-folding type display device according to the invention.

FIG. 7 illustrates an exploded perspective view of the hinge structure for an in-folding type display device according to the invention.

FIG. 8 is an exploded perspective view including a state in which a pair of connecting plates are installed in a rotation module in the hinge structure for an in-folding type display device according to the invention.

FIG. 9 illustrates a partially exploded perspective view of Parts A, B, and C of the hinge structure for an in-folding type display device according to the invention.

FIG. 10 is an exploded perspective view of Part A in FIG. 9.

FIG. 11 is an exploded perspective view of Part B in FIG. 9.

FIG. 12 is an exploded perspective view of Part C in FIG. 9.

FIG. 13 is an exploded perspective view illustrating assembly of four gear fixing cams and a moving cam in a state in which a first rotation unit and a second rotation unit are installed according to the invention.

FIG. 14 is an exploded perspective view illustrating the moving cam in a state in which the second rotation unit and four gear fixing cams are assembled according to the invention in FIG. 13.

FIG. 15 is a perspective view and a plan view separately illustrating the moving cam and the gear fixing cam according to the invention.

FIG. 16 is an internal plan view illustrating an internal structure of the hinge structure for an in-folding type display device according to the invention.

FIG. 17 is a partial plan view illustrating movement of the gear fixing cam, the moving cam, and a rotation rod in a state in which the connecting plates have been unfolded in the hinge structure for an in-folding type display device according to the invention.

FIG. 18 is a perspective view illustrating movement of the first and second rotation units, the gear fixing cam, the moving cam, and a rotation rod in a state in which the connecting plates have been unfolded in the hinge structure for an in-folding type display device according to the invention.

FIG. 19 is a plan view illustrating movement of the first and second rotation units, the gear fixing cam, the moving cam, and the rotation rod in a state in which the connecting plates are being folded in the hinge structure for an in-folding type display device according to the invention.

FIG. 20 is a plan view illustrating movement of the first and second rotation units, the gear fixing cam, the moving cam, and the rotation rod in a state in which the connecting plates are being folded in the hinge structure for an in-folding type display device according to the invention.

FIG. 21 is a plan view illustrating movement of the gear fixing cam, the moving cam, and a rotation rod in a state in which the connecting plates have been fully folded in the hinge structure for an in-folding type display device according to the invention.

FIG. 22 is a perspective view illustrating movement of the first and second rotation units, the gear fixing cam, the moving cam, and a rotation rod in a state in which the connecting plates have been fully folded in the hinge structure for an in-folding type display device according to the invention.

FIG. 23 is a cross-sectional front view illustrating movement of a connection gear and an arm gear with movement of the pair of connecting plates in the hinge structure for an in-folding type display device according to the invention.

FIG. 24 is an exploded perspective view illustrating another example of the rotation unit module illustrated in FIG. 10.

### REFERENCE SIGNS LIST

6: Flexible display panel, 10: Upper panel
14: Lower cover, 30: Connecting plate, 50: Moving cam
52: Connection gear, 53: Cam, 54: Arm gear
55: Cam, 56: Guide groove, 57: Connection bar
59: Rotation guide, 72: First rotation link, 75: Second rotation link
150, 155: Long protrusion, 151, 156: Protrusion

### DESCRIPTION OF EMBODIMENTS

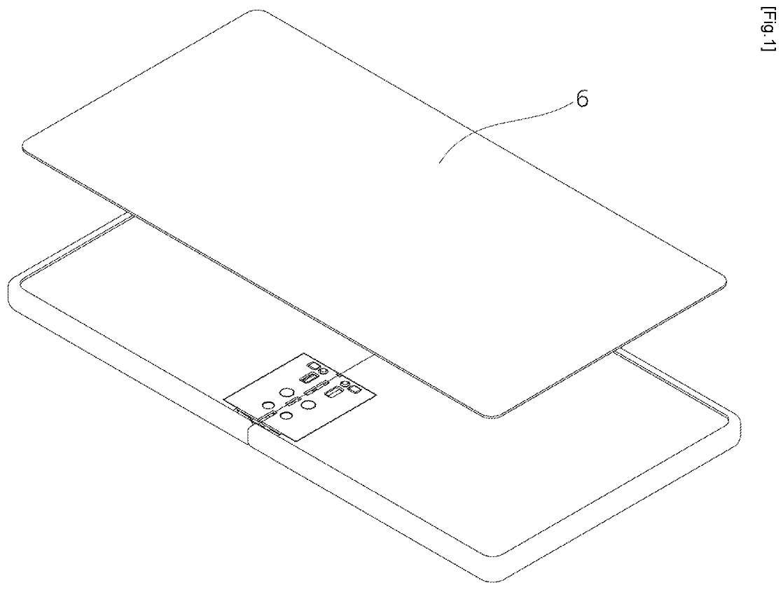

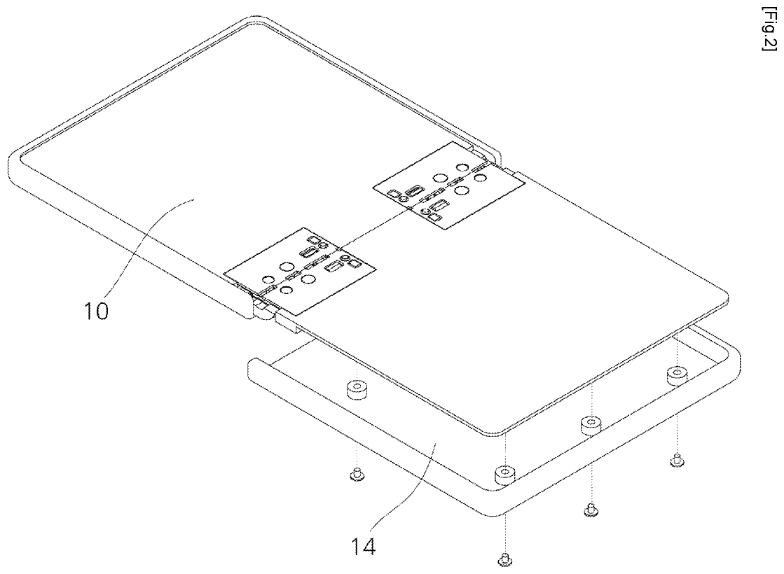

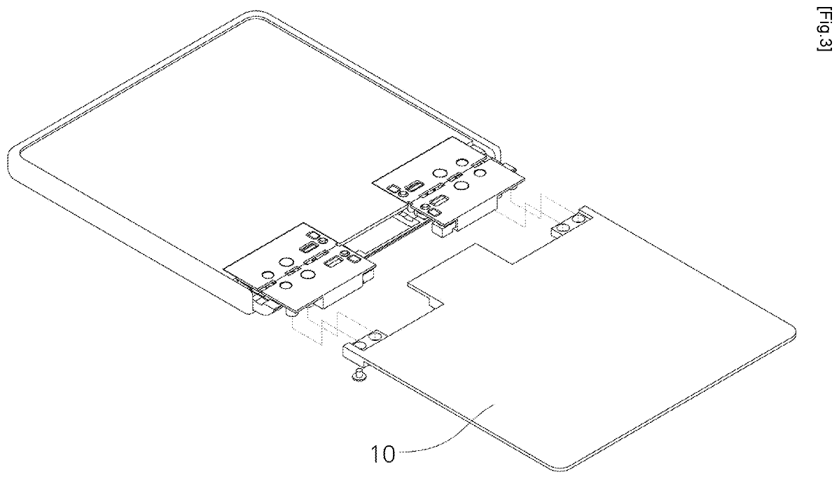

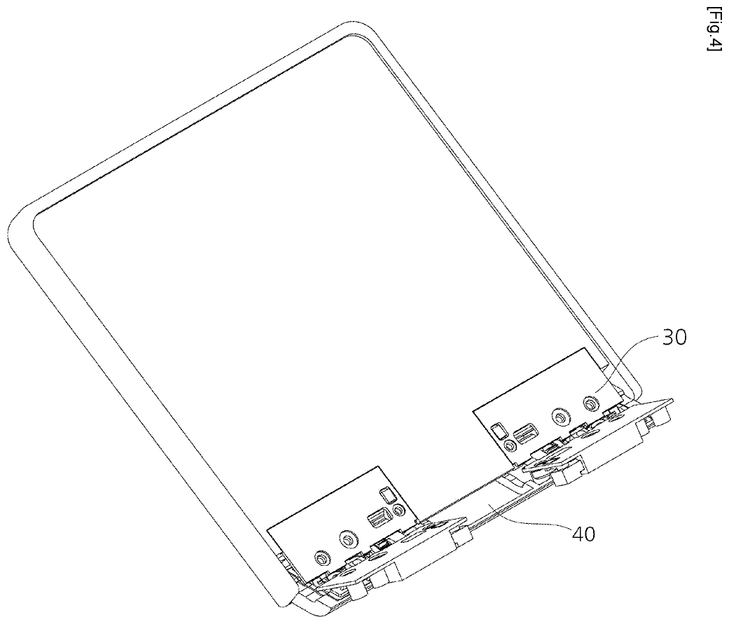

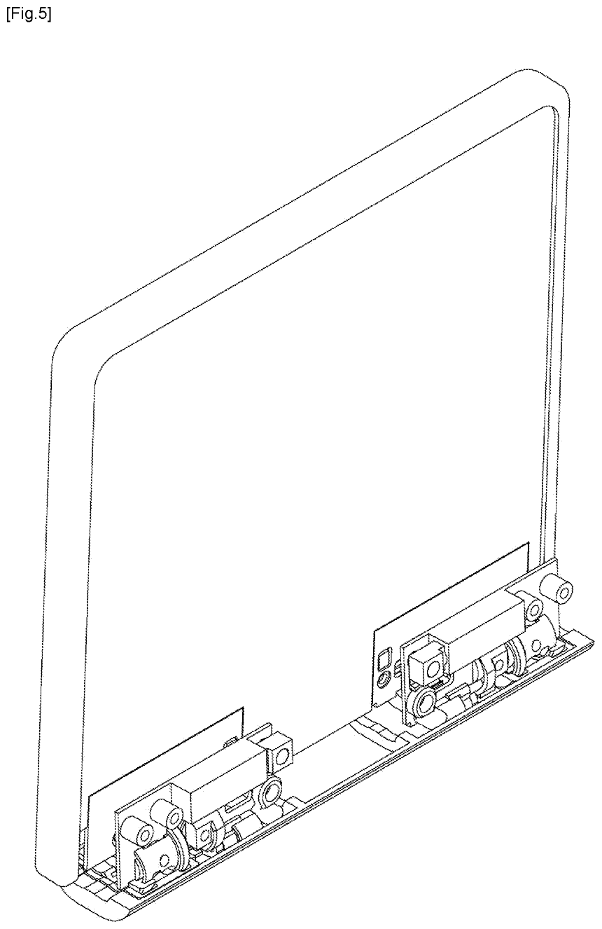

FIG. 1 is a perspective view illustrating a state in which a flexible display panel is installed in a display device in which a hinge structure for an in-folding type display device according to the invention is provided. FIG. 2 is a perspective view illustrating a state in which a lower cover is assembled with a hinge in the display device in which the hinge structure for an in-folding type display device according to the invention is provided. FIG. 3 is a perspective view illustrating a state in which the hinge structure is coupled to one upper panel in the display device in which the hinge structure for an in-folding type display device according to the invention is provided. FIG. 4 illustrates a perspective view of the hinge structure in which the upper panels are being folded in the display device in which the hinge structure for an in-folding type display device according to the invention is provided. FIG. 5 illustrates a perspective view of the hinge structure in which the upper panels have been fully folded in the display device in which the hinge structure for an in-folding type display device according to the invention is provided.

Referring to FIGS. 1 to 5, a hinge structure for an in-folding type display device according to the invention is installed in a central portion in which a pair of upper panels 10 is folded.

The upper panels 10 according to the invention are covered by a lower cover 14. A flexible display panel 6 is installed on the upper panels 10 connected to be folded with the hinge structure according to the invention.

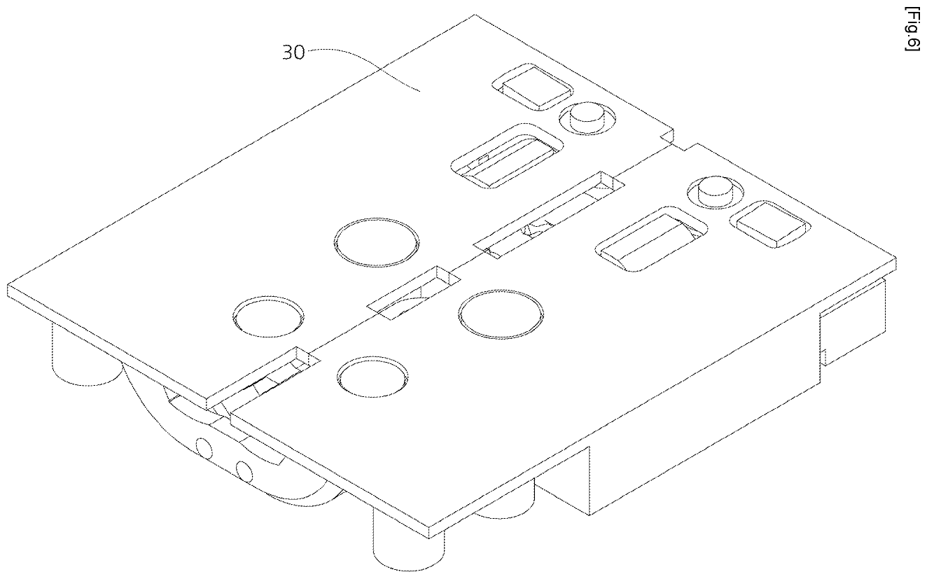

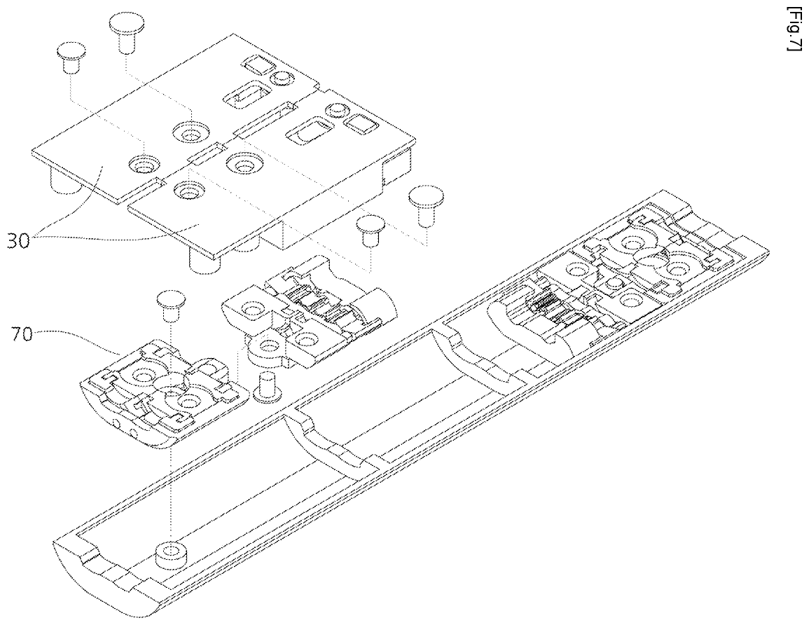

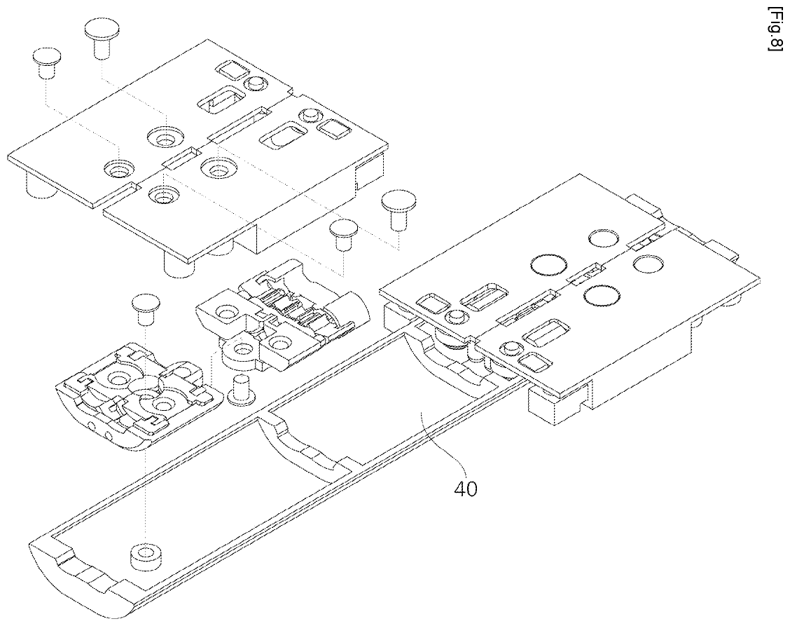

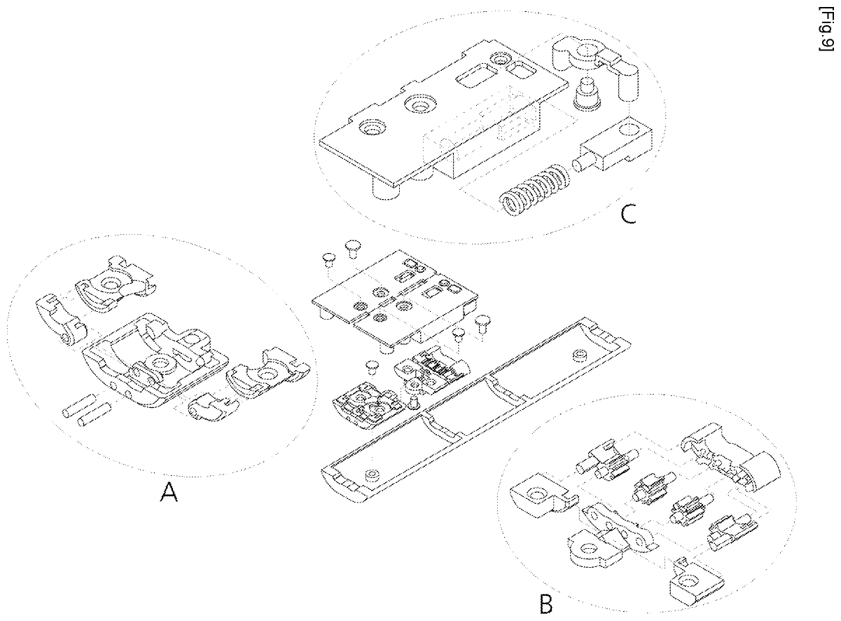

FIG. 6 illustrates a perspective view of the hinge structure for an in-folding type display device according to the invention. FIG. 7 illustrates an exploded perspective view of the hinge structure for an in-folding type display device according to the invention. FIG. 8 is an exploded perspective view including a state in which a pair of connecting plates are installed in a rotation module in the hinge structure for an in-folding type display device according to the invention. FIG. 9 illustrates a partially exploded perspective view of Parts A, B, and C of the hinge structure for an in-folding type display device according to the invention.

Referring to FIGS. 6 to 9, the hinge structure for an in-folding type display device according to the invention includes a pair of connecting plates 30 that is folded in the opposite directions. The connecting plates 30 are connected to the corresponding upper panels 10.

The hinge structure for an in-folding type display device according to the invention is installed in a central case 40.

The hinge structure for an in-folding type display device according to the invention has a configuration in which three parts including Parts A, B, and C illustrated in FIG. 9 are assembled.

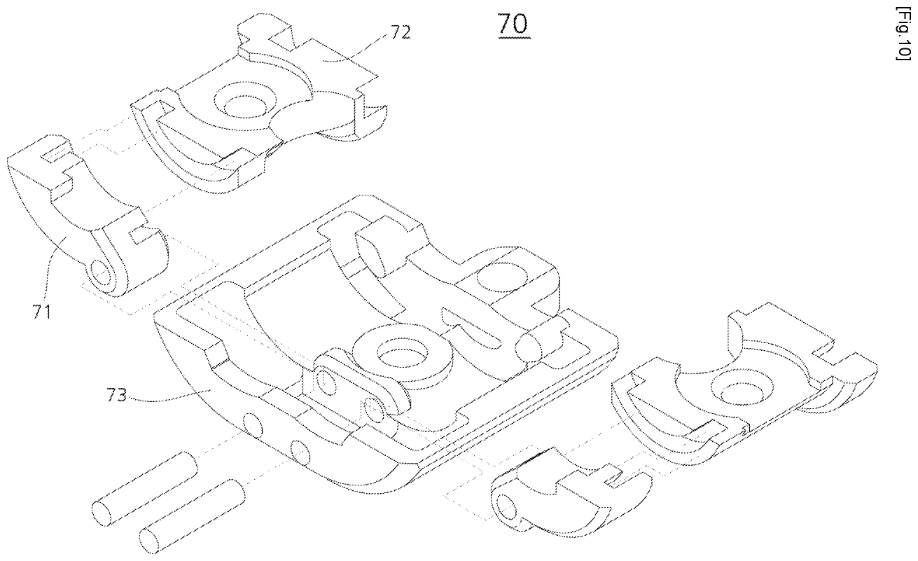

FIG. 10 is an exploded perspective view of Part A in FIG. 9.

Referring to FIG. 10, Part A represents a rotation unit module 70 that causes the pair of connecting plates 30 to rotate in the opposite directions.

The rotation unit module 70 according to the invention includes a pair of first rotation links 72 that is connected to the pair of connecting plates 30 and rotates therewith, rails 71 that are attached to both side surfaces of the first rotation links 72 such that the first rotation links 70 rotate in a curved shape, and a rotation unit body 73 that is connected to the rails 71.

The rails 71 according to the invention are configured to rotate about a part connected to the rotation unit body 73.

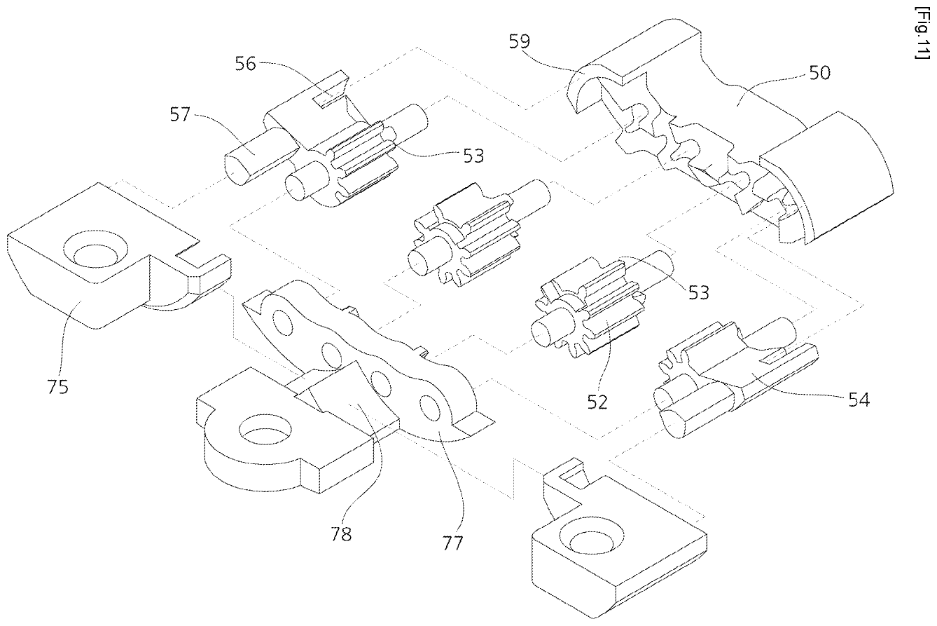

FIG. 11 is an exploded perspective view of Part B in FIG. 9.

Referring to FIG. 11, Part B includes second rotation links 75 that are attached to the connecting plates 30 and rotate with the connecting plates 30, rotation supports 78 that support the second rotation links 75, two connection gears 52 that are located at the center and engage, two arm gears 54 that engage with the connection gears 52, gear connecting portions 77 that support the engagement such that the connection gears 52 and the arm gears 54 rotate, and a moving cam 50 that moves straightly with rotation of the connection gears 52 and the arm gears 54.

Cams 53 and 55 including protrusions and recesses are formed behind the connection gears 52 and the arm gears 54. Protrusions and recesses are also formed in parts of the moving cam 50 coming into contact with the cams 53 and 55.

In each arm gear 54, a connection bar 57 that is inserted into and fixed to the corresponding rotation link 75 and a guide groove 56 that is inserted into the rotation guide 59 of the moving cam 59 such that the arm gear 54 rotates along the rotation guide 59 are formed.

When the second rotation links 75 coupled to the connecting plates 30 rotate in the opposite directions along with the connecting plates 30 and are folded or unfolded, the connection gears 52 and the arm gears 54 also rotate.

The cams 53 and 55 including protrusions and recesses formed behind the connection gears 52 and the arm gears 54 rotate, and the moving cam 50 reciprocates straightly in a direction perpendicular to the rotation direction of the connection gears 52 and the arm gears 54.

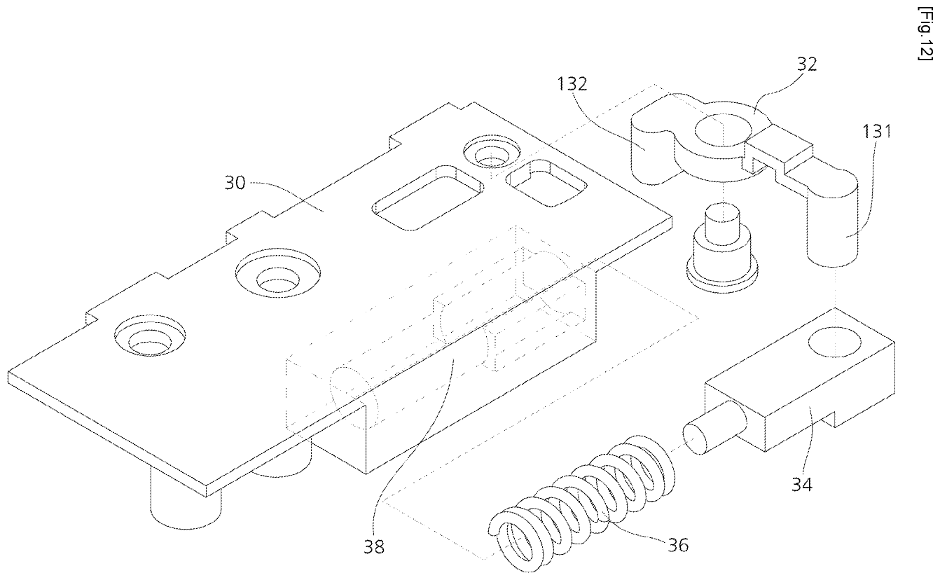

FIG. 12 is an exploded perspective view of Part C in FIG. 9.

Referring to FIG. 12, a rotation rod 32 is connected to each connecting plate 30 and is configured to rotate about a position connected to the corresponding connecting plate 30.

Second ends 132 of a pair of rotation rods 32 are configured to come into contact with the moving cam 50. First ends 131 are configured to rotate about the other end connected to a rod 34 having a spring 36 installed therein.

The rod 34 having the spring 36 installed therein is accommodated in an accommodation portion 38 in the corresponding connecting plate 30. The first ends 131 of the rotation rods 32 and the rods 34 are configured to compress the springs 36 accommodated in the accommodation portions 38 while moving in a direction opposite to the direction in which the moving cam 50 moves when the moving cam 50 moves to be separated away from the connection gears 52 and the arm gears 54.

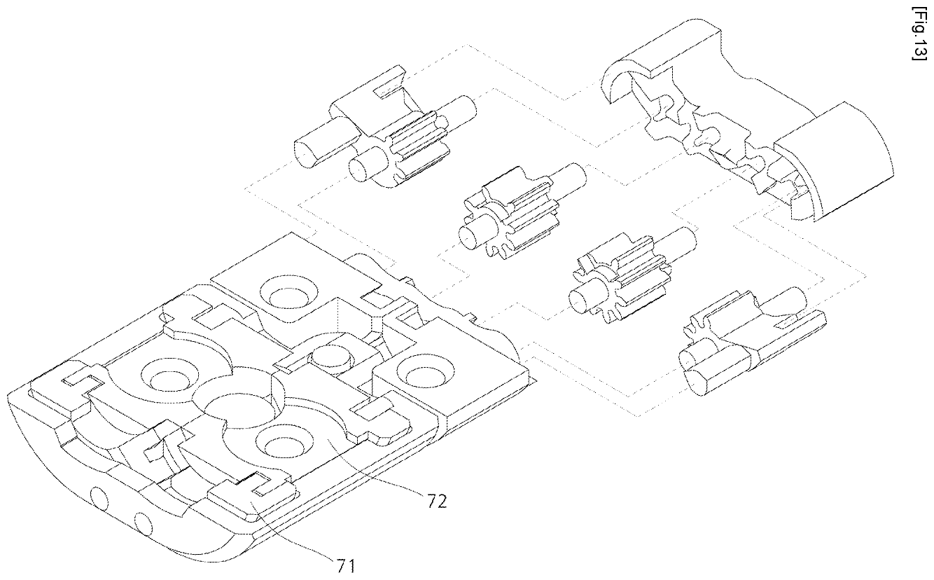

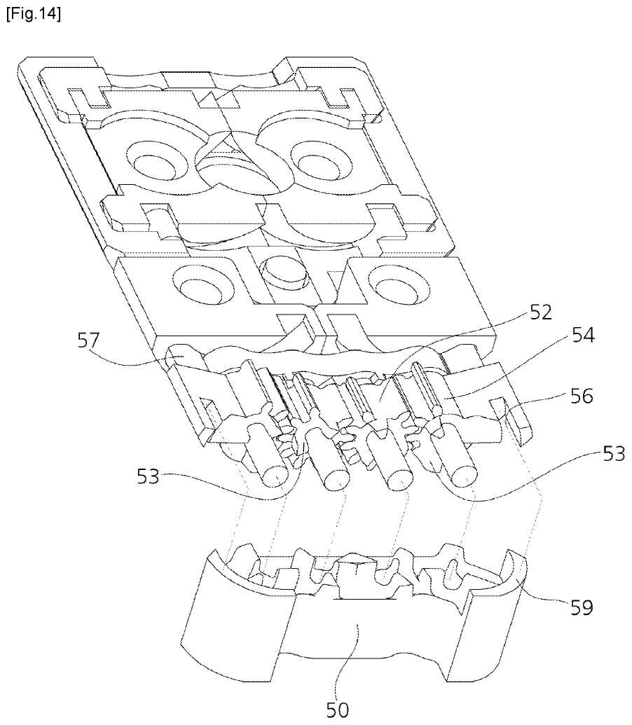

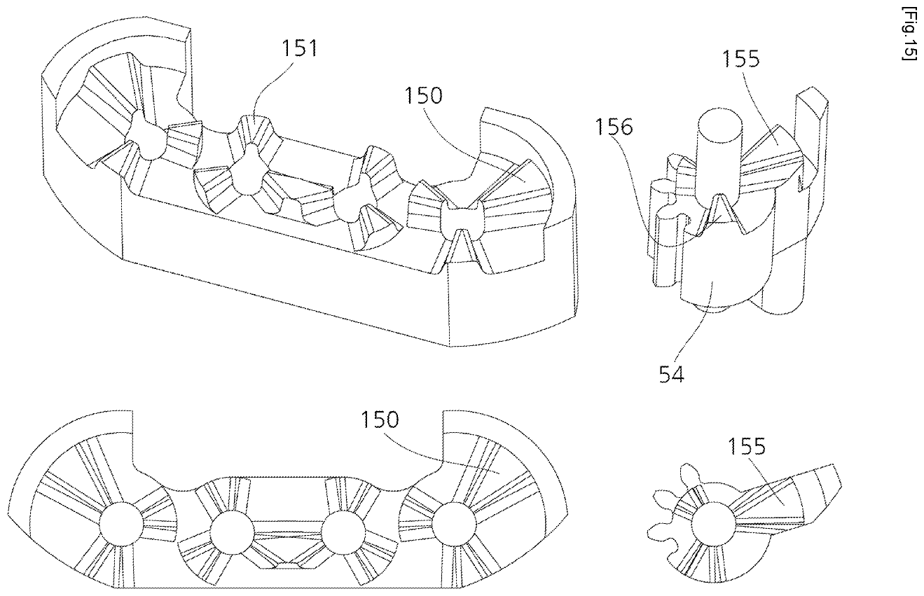

FIG. 13 is an exploded perspective view illustrating assembly of four gear fixing cams and a moving cam in a state in which a first rotation unit and a second rotation unit are installed according to the invention. FIG. 14 is an exploded perspective view illustrating the moving cam in a state in which the second rotation unit and four gear fixing cams are assembled according to the invention in FIG. 13. FIG. 15 is a perspective view and a plan view separately illustrating the moving cam and the gear fixing cam according to the invention.

Referring to FIGS. 13 to 15, rotating cams 53 and 55 including protrusions and recesses are formed in parts in which the connection gears 52 and the arm gears 54 come into contact with the moving cam 50.

Accordingly, when the protrusions of the cams 53 and 55 come into contact with the protrusions of the moving cam 50 while the connection gears 52 and the arm gears 54 are rotating, the moving cam 50 moves straightly in a direction in which it is separated away from the connection gears 52 and the arm gears 54.

Long protrusions 150 and 155 which are formed to be long are formed in parts of the arm gears 54 and the moving cam 50 coming into contact with the arm gears 54.

The long protrusions 150 and 155 can increase an area of the protrusions and extend a period of time in which the protrusions of the moving cam 50 are worn by rotation of the cams 53 and 55.

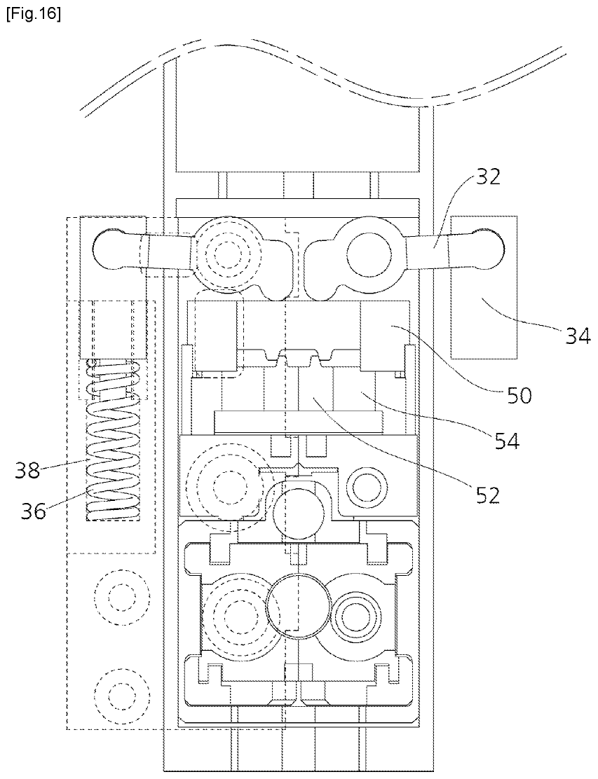

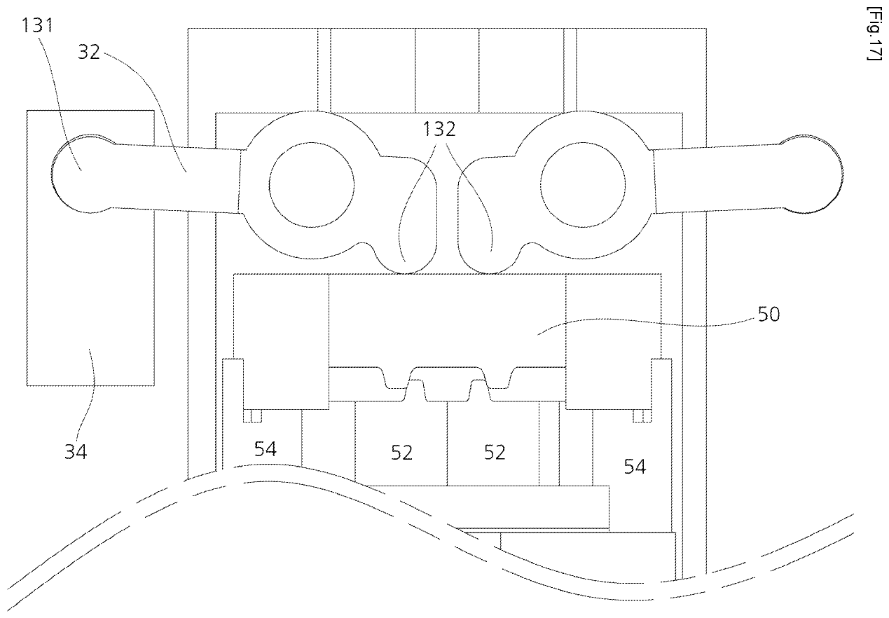

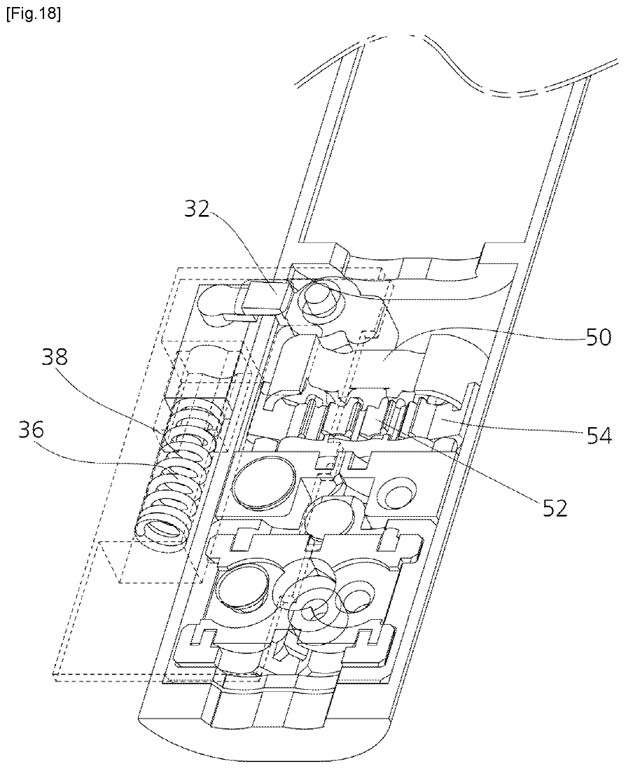

FIG. 16 is an internal plan view illustrating an internal structure of the hinge structure for an in-folding type display device according to the invention. FIG. 17 is a partial plan view illustrating movement of the gear fixing cam, the moving cam, and a rotation rod in a state in which the connecting plates have been unfolded in the hinge structure for an in-folding type display device according to the invention. FIG. 18 is a perspective view illustrating movement of the first and second rotation units, the gear fixing cam, the moving cam, and a rotation rod in a state in which the connecting plates have been unfolded in the hinge structure for an in-folding type display device according to the invention.

Referring to FIGS. 16 to 18, in a state in which the pair of upper panels 10 of the hinge structure for an in-folding type display device according to the invention has been unfolded, the connection plates 30 connected to the upper panels 10 are also in an unfolded state.

When the connecting plates 30 are unfolded, the springs 36 accommodated in the accommodation portions are not compressed.

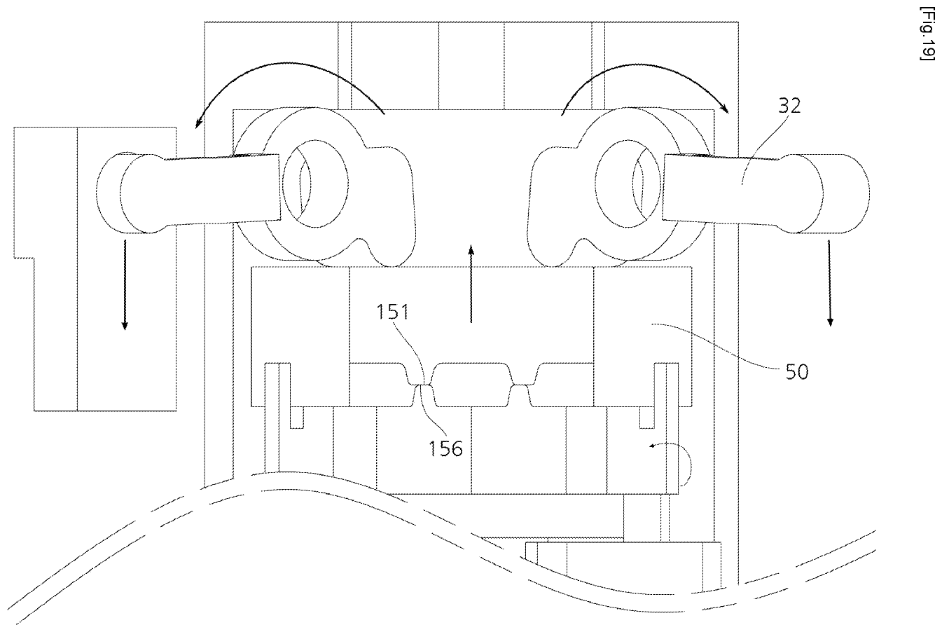

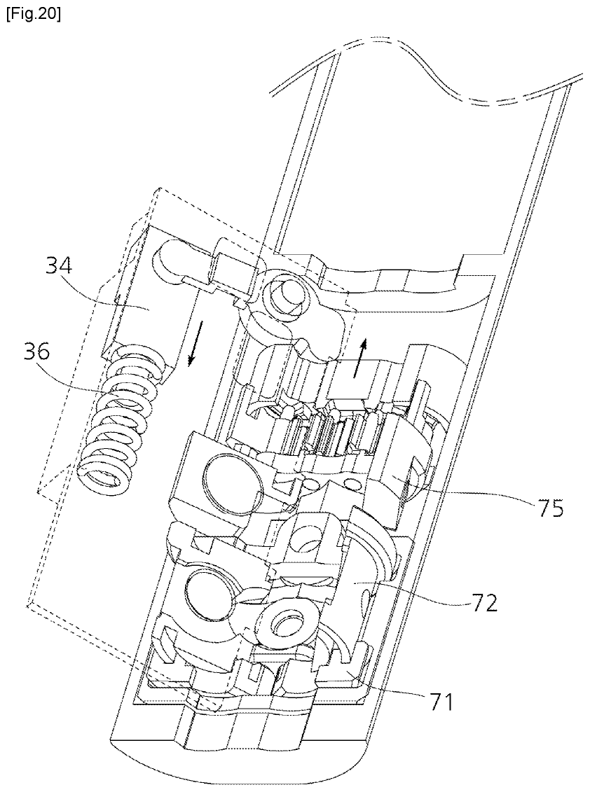

FIG. 19 is a plan view illustrating movement of the first and second rotation units, the gear fixing cam, the moving cam, and the rotation rod in a state in which the connecting plates are being folded in the hinge structure for an in-folding type display device according to the invention. FIG. 20 is a plan view illustrating movement of the first and second rotation units, the gear fixing cam, the moving cam, and the rotation rod in a state in which the connecting plates are being folded in the hinge structure for an in-folding type display device according to the invention.

Referring to FIGS. 19 and 20, when a user folds the upper panels 10 by about 45 degrees, the first rotation links 72 and the second rotation links 75 fixed to the connecting plates 30 rotate together.

The arm gears 54 connected to the second rotation links 75 rotate, and the connection gears 52 engaging therewith also rotate.

When the arm gears 54 and the connection gears 52 rotate, the cams 53 and 55 including protrusions and recesses moves the moving cam 50 in a direction indicated by an arrow while they are rotating.

When the protrusions of the cams 53 and 55 and the protrusions of the moving cam 50 come into contact with each other, the moving cam 50 moves to be separated away from the cams 53 and 55 in the direction indicated by the arrow.

when the moving cam 50 moves, the moving cam 50 causes the rotation rods 32 to rotate, and the rods 34 compress the springs 36 accommodated in the accommodation portions 38.

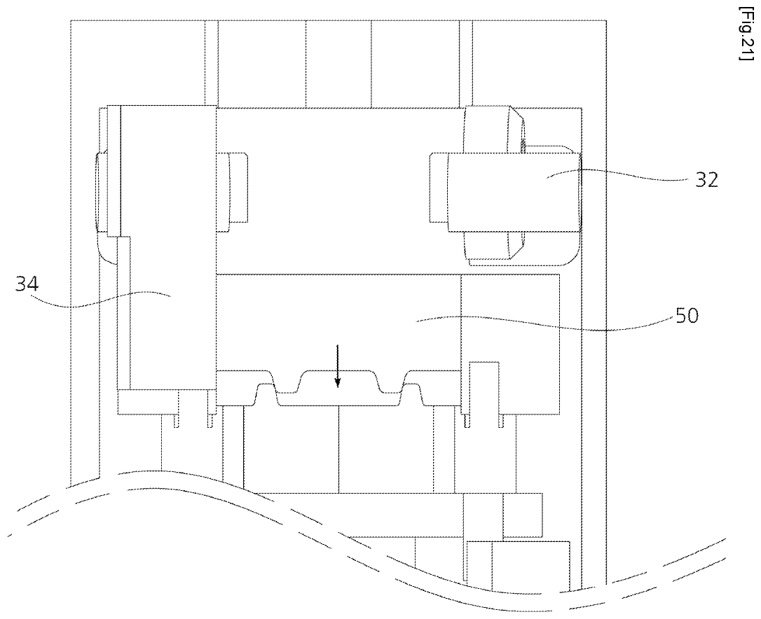

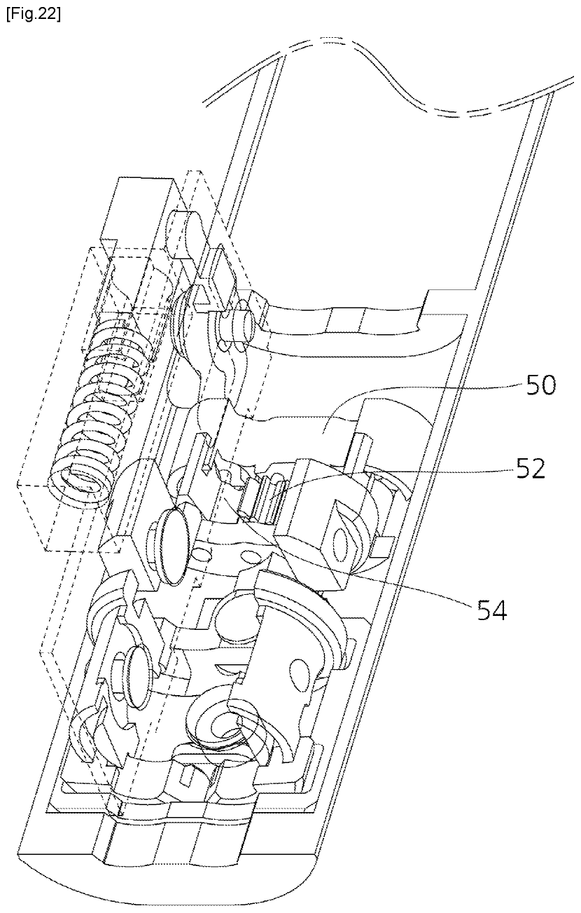

FIG. 21 is a plan view illustrating movement of the gear fixing cam, the moving cam, and a rotation rod in a state in which the connecting plates have been fully folded in the hinge structure for an in-folding type display device according to the invention. FIG. 22 is a perspective view illustrating movement of the first and second rotation units, the gear fixing cam, the moving cam, and a rotation rod in a state in which the connecting plates have been fully folded in the hinge structure for an in-folding type display device according to the invention.

Referring to FIGS. 21 and 22, when the user further folds the upper panels 10 by about 45 degrees or greater, the protrusions and the protrusions do not come into contact in the parts in which the cams 53 and 55 and the moving cam 50 come into contact.

Accordingly, the moving cam 50 is returned to the original state such that it comes into contact with the connection gears 52 and the arm gears 54 with the restoration force of the compressed springs 36, the second rotation links 75 connected to the arm gears 54 rotates to be folded while the connection gears 52 and the arm gears 54 rotate, and the connecting plates 30 are fully folded without a force being applied by a user.

That is, by the restoration force of the compressed springs 36, the upper panels 10 are fully folded without a force being applied by a user.

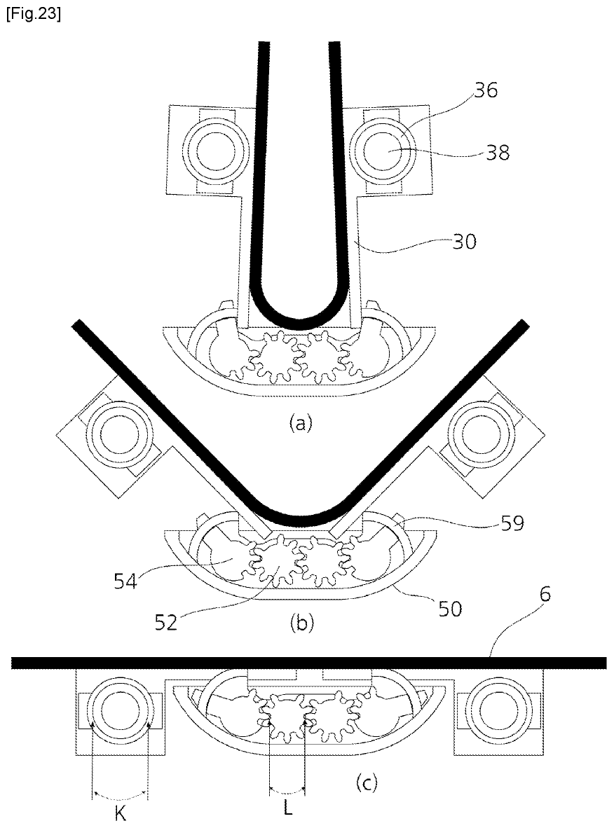

FIG. 23 is a cross-sectional front view illustrating movement of a connection gear and an arm gear with movement of the pair of connecting plates in the hinge structure for an in-folding type display device according to the invention.

Referring to FIG. 23, in a foldable type hinge using a cam according to the related art, springs which are elastic member are located at the positions of the connection gears and the arm gears 52 and 54 or behind the moving cam 50. Accordingly, the diameter of a coil spring which is used is limited by a diameter (L) or the like of a gear.

In the invention, by locating the positions of the springs 36 which are elastic members inside of the connecting plates 30 which are outside of the positions of the gears or the cams, a diameter (K) of a coil spring which is used may be larger than the diameter (L) of the coil spring in the related art.

With this configuration, a coil spring with a sufficient elastic force can be used even if the weights of both panels of a foldable smartphone are large.

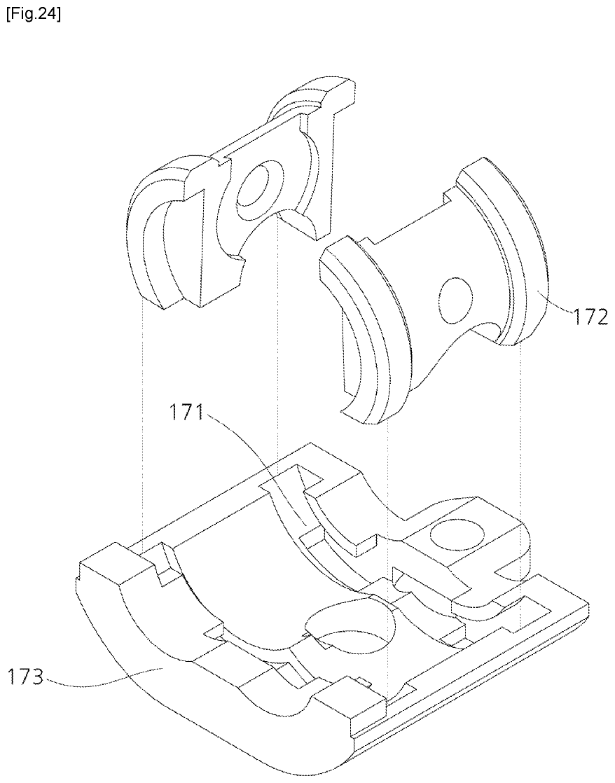

FIG. 24 is an exploded perspective view illustrating another example of the rotation unit module illustrated in FIG. 10.

Referring to FIG. 24, another example of the rotation unit module 70 illustrated in FIG. 10 includes a pair of first rotation links 172 that are connected to the connecting plates 30 and rotate therewith and a rotation unit body 73 that has an arc-shaped rail groove 171 famed therein such that the first rotation links 172 are inserted thereinto and rotate together.

The first rotation links 172 are configured to rotate along the rail grooves 171 formed in an arc shape in the rotation unit body 73.

The rotation unit module according to this example has a configuration in which the first rotation links 172 are directly connected to the rotation unit body 173 and rotate without using the rail 71 illustrated in FIG. 10.

While an exemplary embodiment of the invention has been described above using specific teams, such description is only for explanation and it is obvious that the embodiment can be modified in various forms without departing from the technical spirit and scope of the appended claims. Such modified embodiments should not be understood separately from the spirit and scope of the invention and should belong to the appended claims.

1. A hinge structure for an in-folding type display device, the hinge structure comprising:
a pair of connecting plates that rotates in opposite directions;
an elasticity unit that provides an elastic force to rotation of the connecting plates;
a plate connecting portion that connects the pair of connecting plates; and
an elastic connecting portion that connects the connecting plates and the elasticity unit by causing the elasticity unit to generate an elastic force when the pair of connecting plates rotate.

2. The hinge structure for an in-folding type display device according to claim 1, wherein a rotating cam that rotates and a moving cam that moves straightly when the rotating cam rotates are provided in the plate connecting portion.

3. The hinge structure for an in-folding type display device according to claim 1, wherein a rotation link that supports rotation of the connecting plates is provided in the plate connecting portion.

4. The hinge structure for an in-folding type display device according to claim 3, wherein the rotation link rotates along a rail connected to a rotation unit body, and
wherein the rail rotates about a portion connected to the rotation unit body.

5. The hinge structure for an in-folding type display device according to claim 2, wherein a long protrusion longer than the other protrusion is formed in the rotating cam and the moving cam.

6. The hinge structure for an in-folding type display device according to claim 2, wherein a diameter of the elasticity unit is greater than a diameter of the rotating cam.
